(19) United States
(12) Patent Application Publication
(10) Pub. No.: US 2008/0153371 A1
(43) Pub. Date: Jun. 26, 2008

(54) Humidity Regulating Composite Materials

(75) Inventors: Dennis Losch, Altrip (DE); Stefan Bruhns, Mannheim (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 11/908,322

(22) PCT Filed: Apr. 3, 2006
(86) PCT No.: PCT/EP2006/061287

§ 371 Date: Sep. 11, 2007

(30) Foreign Application Priority Data
Apr. 4, 2005 (DE) 10 2005 015 536.7

(51) Int. Cl. B32B 5/02; B05D 3/00

(52) U.S. Cl. 442/118; 428/411.1; 427/385.5; 427/389.9

(57) ABSTRACT

The invention concerns moisture-regulating composites comprising a sheetlike carrier material, a water-soluble hygroscopic substance and a water-absorbing polymer polymerized onto the carrier material in the presence of the hygroscopic substance, methods of making them and their use for moisture regulation.

The present invention relates to moisture-regulating composites, methods of making them and their use for moisture regulation.

Further embodiments of the present invention are discernible from the claims, the description part and the examples. It will be appreciated that the hereinbefore identified and the hereinafter still to be more particularly described features of the present invention's subject matter are utilizable not just in the particular combination indicated but also in other combinations without leaving the realm of the present invention.

Water-absorbing polymers are in particular polymers of (co)polymerized hydrophilic monomers, graft (co)polymers of one or more hydrophilic monomers on a suitable grafting base, crosslinked ethers of cellulose or of starch, crosslinked carboxymethylcellulose, partially crosslinked polyalkylene oxide or natural products swellable in aqueous fluids, examples being guar derivatives. Such polymers are used as products capable of absorbing aqueous solutions to produce diapers, tampons, sanitary napkins or other hygiene articles, but also as water-containing agents in market gardening.

The production of water-absorbing polymers is described in the monograph “Modern Superabsorbent Polymer Technology”, F. L. Buchholz and A. T. Graham, Wiley-VCH 1998, pages 69 to 117.

WO-A-01/56625, EP-A-1 178 149 and U.S. Pat. No. 5,962,068 describe processes for producing water-absorbing composites in each of which water-absorbing polymers are polymerized onto a carrier material.

WO-A-00/64311 discloses composites wherein water-absorbing polymers were polymerized onto a carrier material. The composites are used for moisture regulation in seat padding. JP-A-05-105705 describes nondeliquescent driers consisting of a carrier material and hygroscopic salts wherein the hygroscopic salts are fixed to the carrier material by means of water-absorbing polymers. The present invention has for its object to provide moisture-regulating composites capable of reversibly taking up large amounts of water vapor. The present invention further has for its object to provide water-vapor-absorbing composites possessing high mechanical stability.

We have found that this object is achieved by moisture-regulating composites comprising

a) at least one sheetlike carrier material,

b) at least one water-soluble hygroscopic substance, and

c) at least one water-absorbing polymer polymerized onto said carrier material a) in the presence of said substance b),

wherein the ratio of said hygroscopic substance b) to said polymer c) is between 0.01 and 1.

The ratio of hygroscopic substance b) to polymer c) is preferably less than 0.8, more preferably less than 0.6, even more preferably less than 0.5 and most preferably less than 0.4 and at least 0.05, more preferably at least 0.1 and even more preferably at least 0.15.

The carrier materials a) are not subject to any restriction. Preferred carrier materials are wovens and/or webs as described in WO-A-01/56625 at page 16 line 40 to page 20 line 27.

Suitable carrier materials a) are for example wovens or webs composed of synthetic polymeric fibers. The fibers may be made of any spinnable polymeric material, examples being polyolefins, such as polyethylene or polypropylene, polyesters, such as polyethylene terephthalate, polyamides, such as nylon-6 or nylon-6,6, polyacrylates, modified celluloses, such as cellulose acetate. Mixtures of abovementioned polymeric materials can be used as well.

Wovens are articles of manufacture which consist of crossed threads, preferably threads crossing at right angles.

Webs are nonwoven articles of manufacture which are composed of fibers and whose integrity is generally due to the intrinsic dinginess of the fibers. Webs are preferably consolidated mechanically, for example by needling, interlooping or entangling by means of sharp jets of water or air. Webs can also be consolidated adhesively or cohesively. Adhesively consolidated webs are obtainable for example by interadhering the fibers with liquid binders or by melting binding fibers which were added to the web in the course of its production. Cohesively consolidated webs are obtainable for example by incipiently dissolving the fibers with suitable chemicals and applying pressure.

The basis weight of the carrier materials is conveniently in the range from 20 to 200 g/M², preferably in the range from 30 to 150 g/m² and more preferably in the range from 35 to 125 g/m².

The density of the carrier materials is typically in the range from 0.005 to 0.2 g/cm³, preferably in the range from 0.008 to 0.16 g/cm³ and more preferably in the range from 0.01 to 0.14 g/cm³.

Hygroscopic substances b) are capable of absorbing water vapor; that is, water vapor from the air condenses on the hygroscopic substance, causing the water content of the hygroscopic substance b) to increase. Hygroscopic substances b) are for example inorganic salts, such as sodium chloride, lead nitrate, zinc sulfate, sodium perchlorate, chromium oxide or lithium chloride, or at least partly crystalline organic compounds, such as water-soluble polyacrylic acids. Hygroscopic inorganic salts are preferred hygroscopic substances b). Sodium chloride is most preferred.

Particularly advantageous hygroscopic substances b) are compounds where the relative humidity above a saturated aqueous solution at 20° C. equilibrates to less than 95%, preferably less than 90%, more preferably less than 85%, even more preferably less than 80% and at least 40%, preferably at least 45%, more preferably at least 50%, even more preferably at least 55% and most preferably at least 60%.

Relative humidity is the quotient of water vapor pressure and water vapor pressure multiplied by 100%.

Preferably, the hygroscopic substance b) is in a disbursed state in the on-polymerized water-absorbing polymer.

When the moisture-regulating composites of the present invention are used in seat padding for example, relative humidities above 90% are perceived as unpleasant, since the formation of sweat is favored at high atmospheric humidity. Relative humidities below 40%, however, are not advantageous either, since such low relative humidities do nothing to further enhance the seat comfort and only make it more difficult for previously taken-up moisture to desorb in phases of non-use.

The moisture-regulating composites of the present invention are obtainable by polymerization of a monomer solution comprising

i) at least one ethylenically unsaturated monomer,

ii) at least one water-soluble hygroscopic substance,

iii) at least one crosslinker,

iv) optionally one or more ethylenically and/or allylically unsaturated monomers copolymerizable with the monomers mentioned under i), and

v) optionally one or more water-soluble polymers applied to a carrier material and polymerized, wherein the ratio of said hygroscopic substance ii) to said monomer i) is between 0.01 and 1

The ratio of hygroscopic substance ii) to monomer i) is preferably less than 0.8, more preferably less than 0.6, even more preferably less than 0.5 and most preferably less than 0.4 and at least 0.05, more preferably at least 0.1 and even more preferably at least 0.15.

Suitable monomers i) are for example ethylenically unsaturated carboxylic acids, such as acrylic acid, methacrylic acid, maleic acid, fumaric acid and itaconic acid, or derivatives thereof, such as acrylamide, methacrylamide, acrylic esters and methacrylic esters. Preference is given to monomers i) which comprise acidic groups. Acrylic acid and methacrylic acid are particularly preferred monomers. Acrylic acid is most preferred.

The monomers i), in particular acrylic acid, comprise a hydroquinone half ether in an amount which is preferably up to 0.025% by weight. Preferred hydroquinone half ethers are hydroquinone monomethyl ether (MEHQ) and/or tocopherols.

Tocopherol refers to compounds of the following formula:

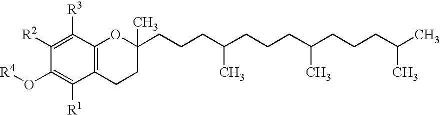

where R¹ is hydrogen or methyl, R² is hydrogen or methyl, R³ is hydrogen or methyl and R⁴ is hydrogen or an acid radical having 1 to 20 carbon atoms.

Preferred R⁴ radicals are acetyl, ascorbyl, succinyl, nicotinyl and other physiologically compatible carboxylic acids. The carboxylic acids can be mono-, di- or tricarboxylic acids.

Preference is given to alpha-tocopherol where R¹═R²═R³=methyl, in particular racemic alpha-tocopherol. R⁴ is more preferably hydrogen or acetyl. RRR-alpha-Tocopherol is preferred in particular.

The hydroquinone half ether content of the monomer solution is preferably not more than 130 weight ppm, more preferably not more than 70 weight ppm, preferably at least 10 weight ppm, more preferably at least 30 weight ppm and particularly preferably around 50 weight ppm, all based on acrylic acid, acrylic acid salts counting as acrylic acid. The monomer solution may be produced for example using an acrylic acid having an appropriate hydroquinone half ether content.

The useful hygroscopic substances ii) for the process of the present invention have already been described as hygroscopic substances b).

The water-absorbing polymers are in a crosslinked state, i.e., the polymerization is carried out in the presence of compounds having at least two polymerizable groups capable of being free-radically interpolymerized into the polymer network. Useful crosslinkers iii) include for example ethylene glycol dimethacrylate, diethylene glycol diacrylate, allyl methacrylate, trimethylolpropane triacrylate, triallylamine, tetraallyloxyethane as described in EP-A-0 530 438, di- and triacrylates as described in EP-A-0 547 847, EP-A-0 559 476, EP-A-0 632 068, WO-A-93/21237, WO-A-03/104299, WO-A-03/104300, WO-A-03/104301 and in DE-A-103 31 450, mixed acrylates which, as well as acrylate groups, comprise further ethylenically unsaturated groups, as described in DE-A-103 31 456 and prior German patent application 103 55 401.7, or crosslinker mixtures as described for example in DE-A-1 95 43 368, DE-A-1 96 46 484, WO-A-90/15830 and WO-A-02/32962.

Useful crosslinkers iii) include in particular N,N′-methylenebisacrylamide and N,N′-methylenebismethacrylamide, esters of unsaturated mono- or polycarboxylic acids of polyols, such as diacrylate or triacrylate, for example butanediol diacrylate, butanediol dimethacrylate, ethylene glycol diacrylate, ethylene glycol dimethacrylate and also trimethylolpropane triacrylate and allyl compounds, such as allyl (meth)acrylate, triallyl cyanurate, diallyl maleate, polyallyl esters, tetraallyloxyethane, triallylamine, tetraallylethylenediamine, allyl esters of phosphoric acid and also vinylphosphonic acid derivatives as described for example in EP-A-0 343 427. Useful crosslinkers iii) further include pentaerythritol diallyl ether, pentaerythritol triallyl ether, pentaerythritol tetraallyl ether, polyethylene glycol diallyl ether, ethylene glycol diallyl ether, glycerol diallyl ether, glycerol triallyl ether, polyallyl ethers based on sorbitol, and also ethoxylated variants thereof. The process of the present invention may utilizes di(meth)acrylates of polyethylene glycols, the polyethylene glycol used having a molecular weight between 300 and 1000.

However, particularly advantageous crosslinkers iii) are di- and triacrylates of 3- to 20-tuply ethoxylated glycerol, of 3- to 20-tuply ethoxylated trimethylolpropane, of 3- to 20-tuply ethoxylated trimethylolethane, especially di- and triacrylates of 2 to 6-tuply ethoxylated glycerol or of 2 to 6-tuply ethoxylated trimethylolpropane, of 3-tuply propoxylated glycerol, or of 3-tuply propoxylated trimethylolpropane, and also of 3-tuply mixedly ethoxylated or propoxylated glycerol, or of 3-tuply mixedly ethoxylated or propoxylated trimethylolpropane, of 15-tuply ethoxylated glycerol, of 15-tuply ethoxylated trimethylolpropane, and of at least 40-tuply ethoxylated glycerol, at least 40-tuply ethoxylated trimethylolethane or of at least 40-tuply ethoxylated trimethylolpropane.

Very particularly preferred crosslinkers iii) are diacrylated, dimethacrylated, triacrylated or trimethacrylated multiply ethoxylated and/or propoxylated glycerols as described for example in WO-A-03/104301. Di- and/or triacrylates of 3- to 10-tuply ethoxylated glycerol are particularly advantageous. Very particular preference is given to di- or triacrylates of 1- to 5-tuply ethoxylated and/or propoxylated glycerol. The triacrylates of 3- to 5-tuply ethoxylated and/or propoxylated glycerol are most preferred. These are notable for particularly low residual levels in the water-absorbing polymer (typically below weight 10 ppm) and the aqueous extracts of water-absorbing polymers produced therewith have an almost unchanged surface tension compared with water at the same temperature (typically not less than 0.068 N/m).

Examples of ethylenically unsaturated monomers iv) which are copolymerizable with the monomers i) are acrylamide, methacrylamide, crotonamide, dimethylaminoethyl methacrylate, dimethylaminoethyl acrylate, dimethylaminopropyl acrylate, diethylaminopropyl acrylate, dimethylaminobutyl acrylate, dimethylaminoethyl methacrylate, diethylaminoethyl methacrylate, dimethylaminoneopentyl acrylate and dimethylaminoneopentyl methacrylate.

Useful water-soluble polymers v) include polyvinyl alcohol, polyvinylpyrrolidone, starch, starch derivatives, polyglycols or polyacrylic acids preferably polyvinyl alcohol and starch.

Hygroscopic polymers, such as soluble polyacrylic acids, can be used not only as hygroscopic substance ii) but also as water-soluble polymer v).

When customary graft polymerization catalysts, for example iron salts, are added to the monomer solution, then the polymers will serve as a grafting base for the polymerization and the monomers to be polymerized will become grafted onto the polymers. When no graft polymerization catalysts are used, then the polymers will survive the polymerization in a substantially unaltered state and act as a hygroscopic substance.

The acid groups of the preferred monomers i) are typically in a partly neutralized state, their degree of neutralization being preferably in the range from 25 to 95 mol %, more preferably in the range from 40 to 90 mol %, even more preferably in the range from 50 to 80 mol % and most preferably in the range from 60 to 80 mol %. Customary neutralizing agents can be used, preference being given to alkali metal hydroxides, alkali metal oxides, alkali metal carbonates or alkali metal bicarbonates and also mixtures thereof. Ammonium salts can be used instead of alkali metal salts. Sodium and potassium are particularly preferred as alkali metals, but most preferred are sodium hydroxide, sodium carbonate or sodium bicarbonate and also mixtures thereof. The neutralization is typically achieved by admixing the neutralizing agent as an aqueous solution, as a melt or else preferably as a solid. For example, sodium hydroxide having a water content of distinctly below 50% by weight can be present as a waxy mass having a melting point of above 23° C. in this case, metering in the piece or as a melt at elevated temperature is possible.

The aqueous monomer solution is applied, preferably by spraying, to the carrier material. Useful carrier materials have already been described as carrier material a).

Subsequently, the monomer solution on the carrier material is polymerized and the composite dried. The polymerization is preferably induced by UV radiation and/or thermally.

The composites of the present invention are very useful for moisture regulation, in particular in mattresses and seat padding, for example in automotive seats.

Seat pads or mattresses comprising the composites of the present invention enhance the seating or lying comfort by regulating the relative atmospheric humidity to a pleasant degree and preventing excessive sweating. At the same time, the composites of the present invention are capable of optimally releasing the sorbed moisture again in phases of non-use and of rapidly regenerating themselves. Owing to this balanced profile of properties the composites of the present invention provide an hitherto unachieved sitting or lying comfort.

Methods:

Determination of Moisture Uptake

The measurements were carried out at an ambient temperature of 23±2° C.

The composites were conditioned at a relative humidity of 50% for 30 minutes until equilibration. The relative humidity was then raised to 90% for 60 minutes (absorption phase). Thereafter, the relative humidity was lowered again to 50% for 30 minutes (desorption phase).

The weight change due to absorption/desorption is continuously measured and is the weight increase based on g of applied substance (water-absorbing polymer and/or salt). The reference point for the weight increase is the weight following 30 minutes of equilibration.

### EXAMPLES

### Example 1

A polyethylene terephthalate web having a basis weight of 70 g/m² was sprayed with a monomer solution before curing by means of UV radiation for 2 minutes. This was followed by drying at 90° C. in a countercurrent dryer for 5 minutes.

The monomer solution comprised 33.6% by weight of sodium acrylate, 8.5% by weight of acrylic acid, 1.51% by weight of polyethylene glycol diacrylate (diacrylate of polyethylene glycol having an average molar mass of 400), 0.22% by weight of 2-hydroxy-1-[4-(hydroxyethoxy)phenyl]-2-methyl-1-propanone and water.

The amount of monomer solution was chosen so that the loading of the polyethylene terephthalate web with on-polymerized water-absorbing polymer was 160 g/m².

The moisture uptake was then measured. The measured results are summarized in Table 1.

### Example 2

The process steps described in Example 1 were followed.

The monomer solution comprised 22.8% by weight of sodium acrylate, 16.9% by weight of acrylic acid, 1.51% by weight of polyethylene glycol diacrylate (diacrylate of polyethylene glycol having an average molar mass of 400), 0.22% by weight of 2-hydroxy-1-[4-(hydroxyethoxy)phenyl]-2-methyl-1-propanone and water.

The amount of monomer solution was chosen so that the loading of the polyethylene terephthalate web with on-polymerized water-absorbing polymer was 160 g/m².

The measured results are summarized in Table 1.

### Example 3

The process steps described in Example 1 were followed.

The monomer solution comprised 36.2% by weight of sodium acrylate, 2.0% by weight of acrylic acid, 1.30% by weight of polyethylene glycol diacrylate (diacrylate of polyethylene glycol having an average molar mass of 400), 0.19% by weight of 2-hydroxy-1-[4-(hydroxyethoxy)phenyl]-2-methyl-1-propanone and water.

The amount of monomer solution was chosen so that the loading of the polyethylene terephthalate web with on-polymerized water-absorbing polymer was 160 g/m².

The measured results are summarized in Table 1.

### Example 4

The process steps described in Example 1 were followed. Following the polymerization, the composite was sprayed with 17 g/m² of sodium chloride as a 25% by weight aqueous solution before drying.

The composite lacked mechanical stability. The sodium chloride which had been sprayed on was easily detached.

### Example 5

The process steps described in Example 1 were followed. The monomer solution comprised 23.7% by weight of sodium acrylate, 6.0% by weight of acrylic acid, 1.06% by weight of polyethylene glycol diacrylate (diacrylate of a polyethylene glycol having an average molar mass of 400), 0.15% by weight of 2-hydroxy-1-[4-(hydroxyethoxy)phenyl]-2-methyl-1-propanone, 7.4% by weight of sodium chloride and water (prepared from a monomer solution as per Example 1 and 42% by weight, based on the monomer solution as per Example 1, of a 25% by weight aqueous sodium chloride solution).

The amount of monomer solution was chosen so that the loading of the polyethylene terephthalate web with on-polymerized water-absorbing polymer/sodium chloride was 160 g/m².

The measured results are summarized in Table 1.

### Example 6

The process steps described in Example 5 were followed. Polyethylene glycol diacrylate in the monomer solution was replaced by 15-tuply ethoxylated trimethylolpropane triacrylate.

The amount of monomer solution was chosen so that the loading of the polyethylene terephthalate web with on-polymerized water-absorbing polymer/sodium chloride was 160 g/m².

The measured results are summarized in Table 1.

### Example 7

The process steps described in Example 3 were followed. The monomer solution comprised 27.8% by weight of sodium acrylate, 1.5% by weight of acrylic acid, 1.00% by weight of polyethylene glycol diacrylate (diacrlate of a polyethylene glycol having an average molar mass of 400), 0.15% by weight of 2-hydroxy-1-[4-(hydroxyethoxy)phenyl]-2-methyl-1-propanone, 5.8% by weight of sodium chloride and water (prepared from a monomer solution as per Example 3 and 30% by weight, based on the monomer solution as per Example 3, of a 25% by weight aqueous sodium chloride solution).

The amount of monomer solution was chosen so that the loading of the polyethylene terephthalate web with on-polymerized water-absorbing polymer/sodium chloride was 160 g/m².

The measured results are summarized in Table 1.

TABLE 1
Moisture uptake

| | | | Weight | Weight |
|---|---|---|---|---|
| | | | increase | increase |
| | Degree of | | after 90 | after 120 |
| Example | neutralization | Salt/polymer | minutes | minutes |
| 1 | 75 mol % | | 0.45 g/g | 0.33 g/g |
| 2 | 50 mol % | | 0.38 g/g | 0.21 g/g |
| 3 | 93 mol % | | 0.56 g/g | 0.38 g/g |
| 5 | 75 mol % | 0.24 | 0.62 g/g | 0.46 g/g |
| 6 | 75 mol % | 0.24 | 0.75 g/g | 0.55 g/g |
| 7 | 93 mol % | 0.19 | 0.78 g/g | 0.64 g/g |

1. A moisture-regulating composite comprising
a) at least one sheetlike carrier material,
b) at least one water-soluble hygroscopic substance, and
c) at least one water-absorbing polymer polymerized onto said carrier material a) in the presence of said hygroscopic substance b),
wherein a ratio of said hygroscopic substance b) to said polymer c) is between 0.01 and 1, and a relative humidity above a supersaturated aqueous solution of said hygroscopic substance b) in equilibrium at 20° C. is at least 40%.

2. The composite according to claim 1 wherein said carrier material a) is a woven fabric and/or a web.

3. The composite according to claim 1 wherein the relative humidity above the supersaturated aqueous solution of said hygroscopic substance b) in equilibrium at 20° C. is less than 95%.

4. The composite according to claim 1 wherein said hygroscopic substance b) is an inorganic salt.

5. The composite according to claim 1 wherein said polymer c) comprises acidic groups.

6. The composite according to claim 5 wherein he said acidic groups are at least 25 mol % neutralized.

7. A process for producing a moisture-regulating composite, which comprises a monomer solution comprising
i) at least one ethylenically unsaturated monomer,
ii) at least one water-soluble hygroscopic substance,
iii) at least one crosslinker,
iv) if appropriate optionally one or more ethylenically and/or allylically unsaturated copolymerizable with monomer i), and
v) optionally one or more water-soluble polymer
being applied to a sheetlike carrier material and polymerized, wherein the a ratio of said hygroscopic substance ii) to said monomer i) is between 0.01 and 1. and the relative humidity above a supersaturated aqueous solution of said hygroscopic substance ii) in equilibrium at 20° C. is at least 40%.

8. The process according to claim 7 wherein said monomer i) comprises acidic groups.

9. The process according to claim 8 wherein said acidic groups are at least 25 mol % neutralized.

10. The process according to claim 7 wherein the relative humidity above the supersaturated aqueous solution of said hygroscopic substance ii) in equilibrium at 20° C. is less than 95%.

11. The process according to claim 7 wherein said hygroscopic substance ii) is an inorganic salt.

12. The process according to claim 7 wherein said carrier material is a woven fabric and/or a web.

13. (canceled)

14. A seat padding or a mattress comprising a composite according to claim 1.

15. A method of regulating moisture in an article comprising incorporating a composite of claim 1 in the article.

16. The method of claim 15 wherein the article is a mattress or a seat padding.
